(19) United States
(12) Patent Application Publication
(10) Pub. No.: US 2015/0069764 A1
(43) Pub. Date: Mar. 12, 2015

(54) VEHICLE DOOR LOCK ACTUATION PREVENTION APPARATUS

(71) Applicant: Toyota Motor Engineering & Manufacturing North America, Inc., Erlanger, KY (US)

(72) Inventor: Norman Charles Kerr, III, Ann Arbor, MI (US)

(73) Assignee: Toyota Motor Engineering & Manufacturing North America, Inc., Erlanger, KY (US)

(21) Appl. No.: 14/020,901

(22) Filed: Sep. 9, 2013

(51) Int. Cl. E05B 77/10; E05B 63/00; E05B 85/10; E05B 77/04; E05B 77/30; B60J 5/04; E05B 65/00

(52) U.S. Cl. CPC E05B 77/10; B60J 5/0458; E05B 63/0052; E05B 65/00; E05B 77/04; E05B 77/30; E05B 85/10
USPC 292/139; 292/336.3

(57) ABSTRACT

A vehicle door opening actuation prevention apparatus includes a thin cross-section spacer coupled to a plate attached to a door handle frame. One end of the spacer is positioned relative to a door lock mounted within a vehicle door to limit the maximum amount of lateral inward movement of the door handle assembly toward the door lock during a side impact force on the vehicle door to prevent movement of the door lock actuator pin to the second door lock unlatch position via movement of the fork coupled to the door handle and engaged with the door lock actuator pin.

### BACKGROUND

The present description relates, in general, to vehicle door locks and, more particularly, to apparatus for preventing actuation of the door lock during a side impact.

Vehicle door locks include an outside mounted pivotal handle, which can be moved in a direction to open the vehicle door. A cable or link couples the handle to the door lock so that movement of the handle in an opening direction causes the cable or link to actuate the door lock to unlatch the door lock and enable the vehicle door to be opened.

Governmental safety standards have requirements for latch performance upon impact or forces applied to the vehicle door, such as during a side impact collision. While various mechanisms have been employed to prevent accidental actuation of the door lock causing opening of the door during a side impact, such mechanisms cannot be employed in all vehicle door configurations due to size constraints.

### SUMMARY

A vehicle door opening prevention apparatus for a vehicle door handle assembly mounted in a door outer panel, with a movable handle accessible exteriorly of the door outer panel. A link is coupled to the handle and is movable with the handle when the handle moves to a door opening position to engage an actuator on a door lock carried by the vehicle door to move the actuator in a direction to unlatch the vehicle door lock. A spacer can be carried on a plate coupled to the door handle assembly extending in a direction toward the door lock to prevent movement of the door handle assembly upon impact or forces applied to the vehicle door, such as during a side impact collision, sufficiently to move the fork in a direction to actuate the door lock actuator, unlatch the door lock, and enable the door to open.

The spacer can be integrally formed with the plate. The spacer extends angularly, and can be substantially perpendicular, from the plate. The spacer has substantially the same thin cross-sectional thickness as the plate.

In another aspect, a door handle apparatus is disclosed for a vehicle door having a door lock assembly for latching and unlatching the vehicle door. The door handle apparatus includes a door handle assembly mounted in a door outer panel of the vehicle door, and carrying a movable handle accessible exteriorly of the vehicle door. The handle is movable relative to the door to a position to open the door. A door lock assembly carried on the door includes an actuator pin movable from a first position in which the door lock is latched to a second position in which the door lock is unlatched to allow opening of the vehicle door. A fork is coupled to the door handle and engaged with the actuator pin for moving the actuator pin to the second position to unlatch the door when the door handle is moved away from the vehicle door. A door operation actuation prevention apparatus is provided on the handle and includes a plate mounted on the handle assembly and a spacer carried on the plate extending toward the door lock within the vehicle door to prevent movement of the door handle assembly toward the door lock assembly upon impact or forces applied to the vehicle door, such as during a side impact collision, a sufficient distance which would cause the fork to move the actuator pin to the second door unlatched position.

In another aspect, a vehicle door includes an outer door panel joined to an inner door panel. A handle frame is mounted in the door outer panel and includes a movable handle. A door lock is mounted to the inner door panel. An actuator pin is coupled to the door lock and is movable from a first position corresponding to a latched position of the door lock and a second position in which the actuator pin unlatches the door lock to allow opening of the vehicle door when the handle is moved relative to the handle frame. A fork carried by the handle is engageable with the actuator pin to move the door lock actuator to the second unlatched position when the handle is moved relative to the vehicle door. A spacer carried on a plate coupled to the handle frame is angularly disposed between the door lock and the plate to limit movement of the handle frame toward the door lock upon impact or forces applied to the vehicle door, such as during a side impact collision, to prevent movement of the door lock actuator pin to the second position thereby preventing unlatching of the door lock.

### BRIEF DESCRIPTION OF THE DRAWING

The various features, advantages and other uses of the present invention will become more apparent by referring to the following detail description and drawing in which:

FIG. 1 is a perspective view of a prior art door handle;

FIG. 2A is a perspective view of a prior art door opening prevention apparatus;

FIG. 2B is a partial, left hand perspective view of the prior art spacer shown in FIG. 2A;

FIG. 3 is a longitudinal cross-sectional view showing a door handle deformation under a side impact force which triggers door lock actuation;

FIG. 5 is one aspect of a longitudinal cross-sectional view showing a door handle lock actuation prevention apparatus;

FIG. 4A is a pictorial representation of a side impact force acting on a door lock release fork;

FIG. 4B is a pictorial representation of a side impact force acting on a door lock release fork and pin where the release pin is actuated;

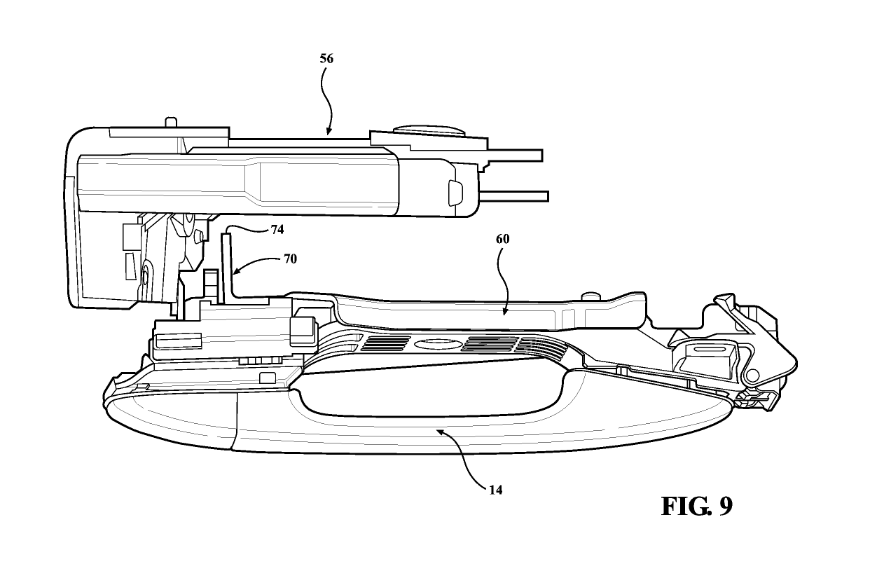

FIG. 5 is a longitudinal cross-sectional view showing one aspect of a door handle lock actuation prevention apparatus;

FIG. 6 is a perspective view of the door handle lock actuation prevention apparatus shown in FIG. 5;

FIG. 7 is an exterior right side elevational view of the door handle lock actuation prevention apparatus shown in FIGS. 5 and 6 mounted between a vehicle door lock and a door handle;

FIG. 8 is a right side perspective view of the door handle, door lock and door handle lock actuation prevention apparatus shown in FIG. 7; and

FIG. 9 is a plan view of the door handle, door lock and door handle look actuation prevention apparatus shown in FIGS. 7 and 8.

### DETAILED DESCRIPTION

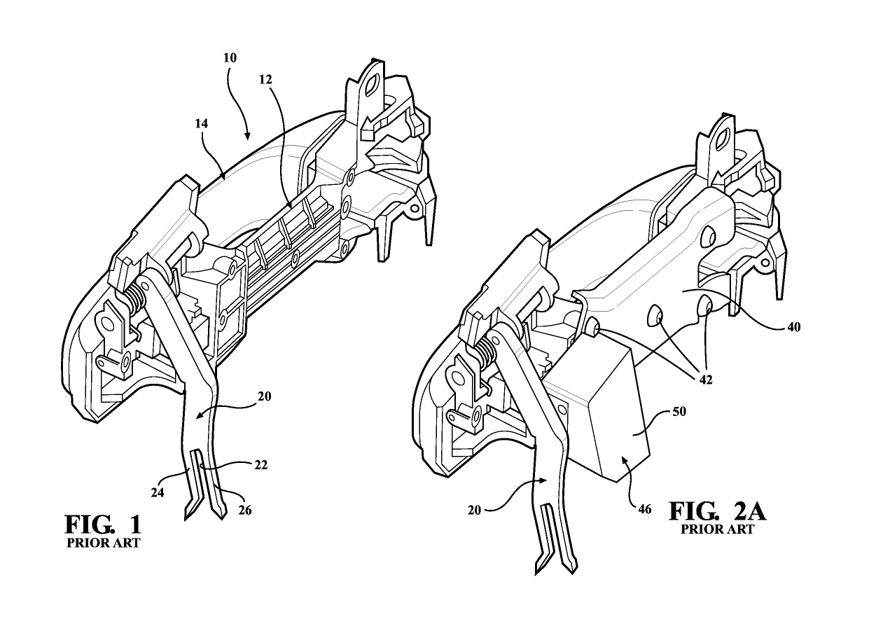

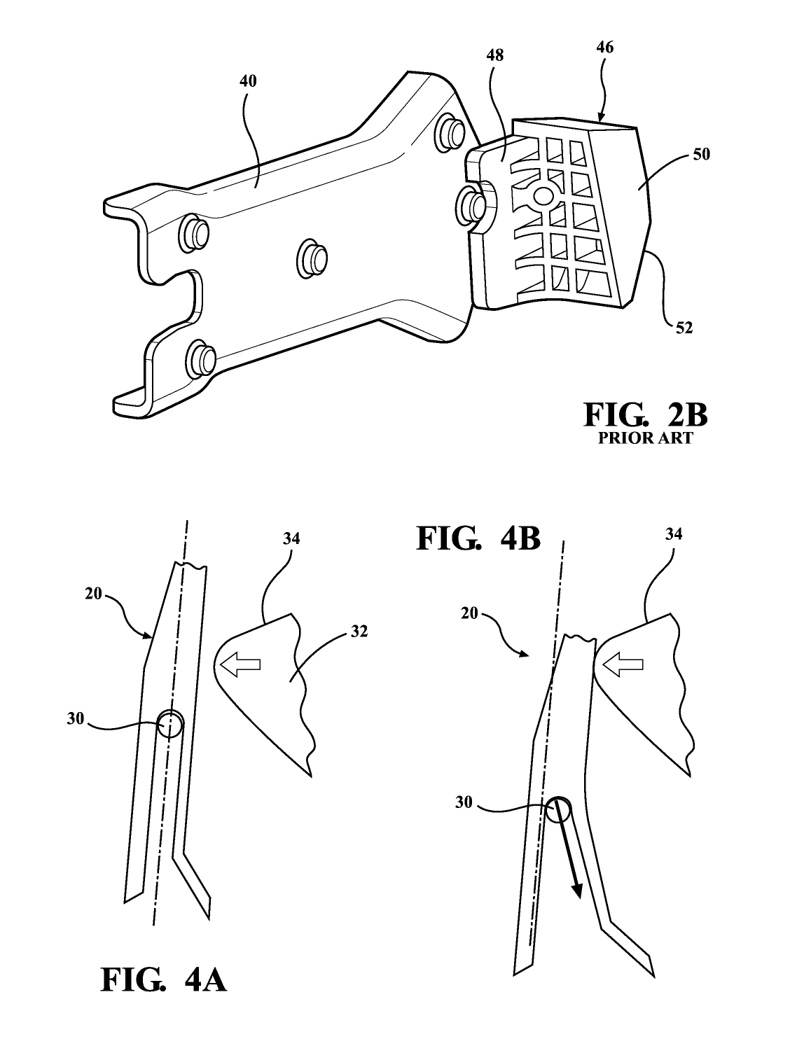

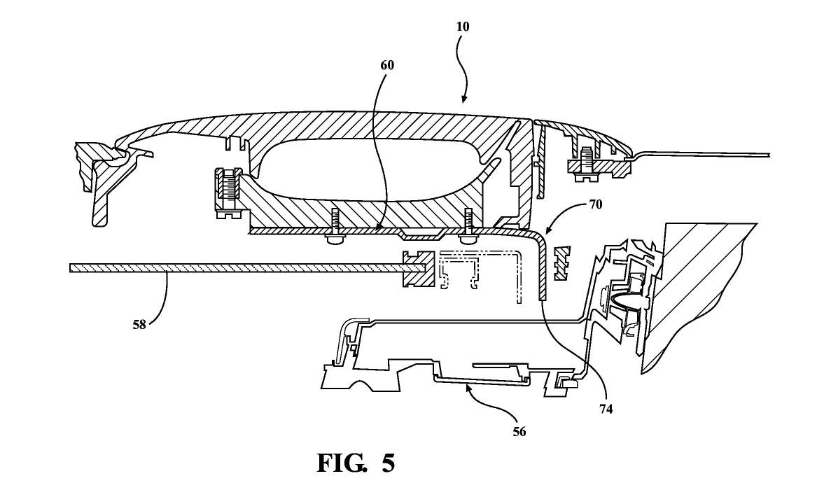

Referring now to the drawing and to FIGS. 1, 2A, and 2B, there is depicted a prior art door handle assembly 10 which is mountable in a vehicle door as generally shown in FIG. 5. The door handle assembly 10 includes a handle frame 12 that supports a movable handle 14. The handle 14 is mounted for movement from a first stationary position to a second position generally exteriorly of the vehicle door in which the handle assembly 10 is mounted. When in the second position, the handle 14 activates a vehicle door lock mounted within the door to unlatch the door and allow user force to pull the door open. The handle 14 may be a pivotal handle that is pivotally mounted with respect to the handle frame 12 for movement about one longitudinal end or is capable of pivotal movement along an entire upper edge. By example, FIGS. 1 and 2A depict a handle 14 mounted to handle frame 12 for pivotal movement about one end.

A link or fork 20 is pivotally coupled to the handle 14 and with movement of the handle 14. The fork 20 moves in a generally vertical up and down direction despite lateral pivotal movement of the handle. The fork 20 includes an open-ended slot 22 at a lower end formed between two spaced legs 24 and 26. As described hereafter, the fork 20 engages a door lock actuator pin 30, shown in FIGS. 4A and 4B, and moves the door lock actuator pin 30 from a first position shown in FIG. 4A corresponding to the closed or latched position of the vehicle door to a second position shown in FIGS. 4B and 8 causing the door lock to unlatch thereby allowing the door to be moved to an open position relative to the vehicle.

In certain situations, a side impact force may be exerted on the door outer panel, such as from a collision with another object. This lateral force shown by reference number 32 in FIG. 4A, if exerted at the appropriate height of the vehicle door, can bend the door outer panel 34 inward as shown in FIG. 4A, a sufficient amount so that the door inner panel 34 strikes the fork 20. As seen in FIG. 8, a force acting on the fork 20 between the actuation pin 30 and the handle frame may cause sufficient movement of the fork 20 to move the actuator pin 30 to the second position unlatching the door lock. This lateral force exerted on the fork 20 causes the fork 20 to move toward its second position, FIG. 4B, even though the door handle 14 has not been moved to the door open position, and cause activation of the door lock actuator pin 30 resulting in an unintentional unlatching of the door lock and a potential opening of the vehicle door.

FIGS. 2A and 2B depict a prior art attempt to prevent inadvertent door lock actuation to an unlatched position under a sideways or lateral imposed force on the vehicle door. In this prior art configuration, a steel plate 40 is coupled by fasteners 42 to the handle frame 12. The plate 40 not only adds strength to the handle frame 12 but also provides a mounting platform for a spacer 46 in the form of a polymer resin molded block that is attached to one end of the plate 40 by fasteners, adhesive, etc. The spacer 46 includes a flange portion 48 which is fixed to the plate 40 and an enlarged three-dimensional, honey combed block portion 50. The block portion 50 extends away from the plate 40 toward the door lock assembly mounted within the vehicle door between the door outer panel and the door inner panel. The projection or length of the block 50 away from the plate 40 is selected so that the outer surface 52 of the block 50 engages the door lock assembly as the entire door handle assembly 10 moves laterally inward under a lateral force exerted on the vehicle door outer panel. Engagement of the surface 52 of the block 50 with the door lock assembly prevents further movement of the handle assembly 10 toward the door lock and prevents sufficient movement of the fork 20 in a downward direction which would cause unintended movement of the door lock actuator pin 30 to the second position in which the door would be unlatched and can be opened.

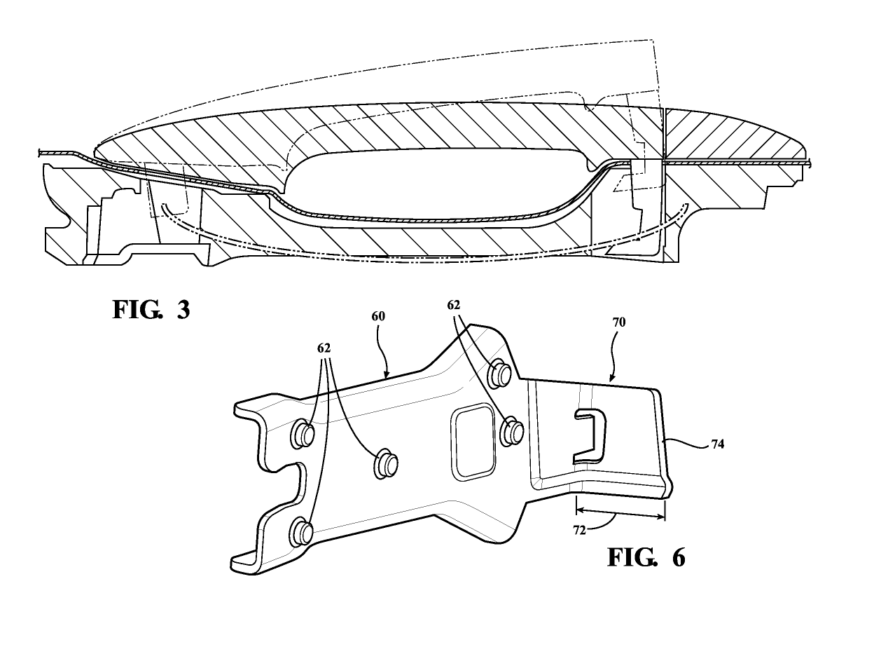

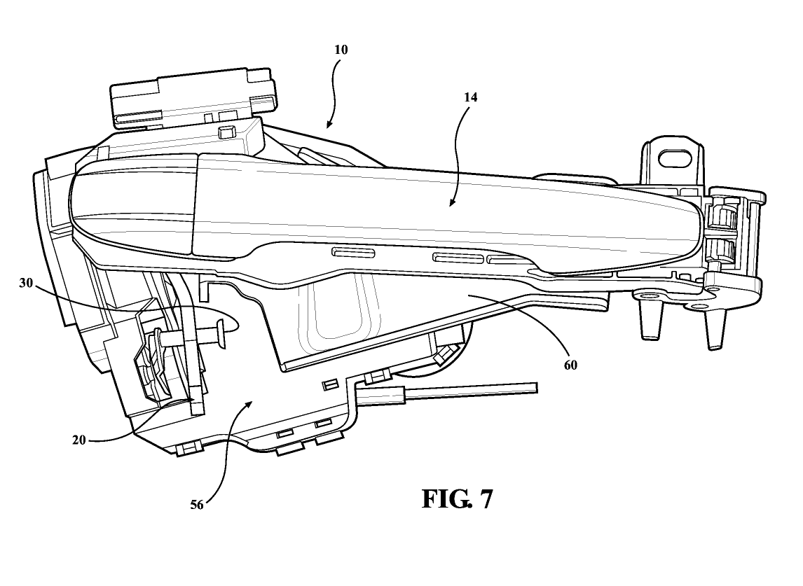

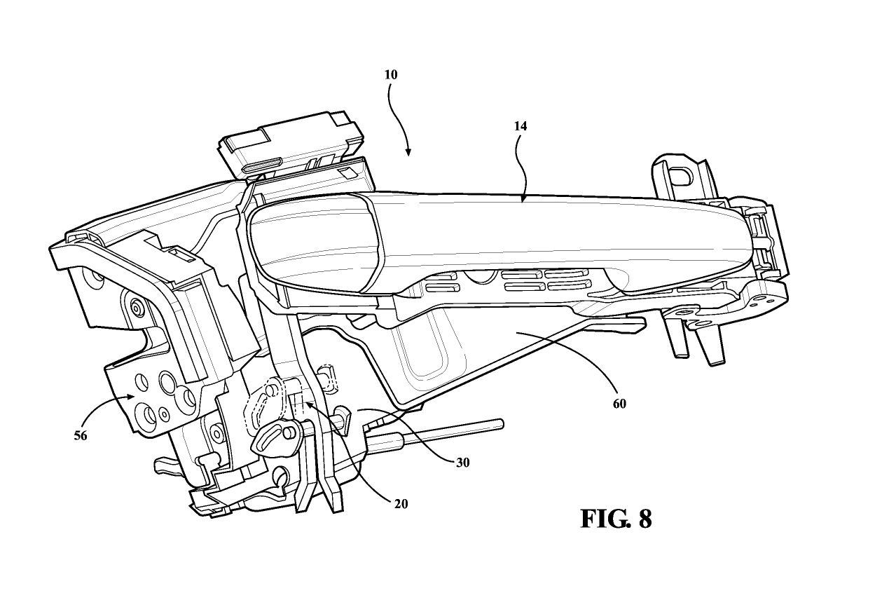

FIG. 3 depicts the door handle frame 12 bowing inward under a lateral force exerted on the door handle assembly 12. This inward movement of the doorframe 12 can also cause engagement of the door handle assembly 10 with the door lock assembly resulting in unintentional actuation of the door lock to the unlatched position.

In certain vehicle door configurations, space constraints restrict the amount of open space between the door handle assembly 10, a door lock assembly 56, and a rear portion of the vehicle door glass 58 as shown in FIG. 5. This limited space availability prevents the use of the spacer 46.

A solution to this problem can be found in FIGS. 5-9 in which a flange 70 in the form of a thin cross-section flange angularly extending from the plate 60 is carried on the plate 60. The flange 70 can, in one aspect, be integrally formed as a bent end portion of the plate 60 and can have the same thin cross-section thickness as the plate 60. Alternately, the flange 70 can be a separate component that is fixedly secured to the plate 60 by fasteners, adhesive, or other attachment means.

The length 72 of the flange 70, which defines the projection or distance that an outer end 74 of the flange 70 extends from a major surface of the plate 60, is chosen so as to limit movement of the plate 50 upon impact or forces applied to the vehicle door, such as during a side impact collision, and the attached handle frame 12 in a direction toward the door lock assembly 56 so as to prevent sufficient movement of the fork 20 which would move the door lock actuator pin 30 toward the second position a sufficient distance to move the door lock to the unlatched position. As shown in FIG. 5, the outer end 74 of the flange 70 can be initially spaced from the door lock assembly 56 in a normal vehicle door closed state. Alternately, the end 70 of the spacer 70 can be in contact with or spaced by only a slight distance from the door lock assembly 56.

The mounting of the flange 70 and the plate 60 on the frame 12 of the door handle assembly 10 in its spaced relationship from the door lock assembly 56 can be seen in FIGS. 7-9.

In one aspect, the thin cross-section spacer 70 carried on the plate 60 forms part of a door handle lock actuation prevention apparatus since the projection or link of the flange 70 from the plate 60 is chosen to minimize the amount of inward movement of the door handle assembly 12 toward the door lock when a sideways impact force is exerted on the door causing the door lock handle assembly 10 to move in an inward direction toward the center of the vehicle. During such movement, an outer edge of the spacer 70 will engage the door lock assembly 56 and stop further lateral inward movement of the door handle assembly 10. This stoppage of inward movement of the door handle assembly 10 by the engagement of the end 74 of the spacer 70 with the door lock assembly 56 occurs before the fork 20 movably coupled to the door handle 14 has moved a sufficient distance downward to move the door lock actuator pin 30 to the second position fully unlatching the door lock. In this manner, the spacer 70 prevents accidental unlatching of the door lock during a side impact on the vehicle door.

In another aspect, the flange 70 carried on the plate 60 forms part of a door handle assembly mountable in a vehicle door. The outer end 74 of the flange 70 extends from the plate 60 mounted on the handle frame 12 a sufficient distance toward the door lock assembly 56 mounted within the interior of the vehicle door to limit the maximum amount of lateral or inward movement of the door handle assembly 10 toward the door lock assembly 56. This maximum amount of inward movement distance is selected through the length of the flange 70 from the plate 60 to prevent movement of the fork 30 coupled to the door handle assembly 10 a sufficient distance so that the door lock assembly 56 is not stroked or actuated or is stroked or actuated insufficiently to not actuate the door lock assembly 56.

The flange 70 carried on the plate 60 also forms part of a vehicle door where the flange 70 and the plate 60 are mounted on the handle frame 12 which is part of the door handle assembly 10 mounted in a vehicle door and laterally spaced from the door lock assembly 56 also mounted within the vehicle door. The fork 20 movably coupled to the door handle 14 engages the door lock actuator pin 30 and is capable of moving the door lock actuator pin 30 to a second position causing an unlatching of the door lock assembly 56 when the door handle 14 is pivoted to an outward position relative to the vehicle door to enable the vehicle door to be opened. The flange 70 carried on the plate 60 attached to the door handle frame 12 limits lateral inward movement of the door handle 14 under a lateral force exerted on the vehicle door, such as during a side collision, to prevent actuation of the door lock assembly 56 to the unlatched position.

What is claimed is:

1. A vehicle door opening prevention apparatus for a vehicle door handle assembly mounted in a door outer panel, with a movable handle accessible exteriorly of the door outer panel, a link coupled to the handle and movable with the handle when the handle moves to an open position to engage an actuator on a door lock carried by the vehicle door to move the actuator in a direction to unlatch the vehicle door lock, the vehicle door opening prevention apparatus comprising:
a spacer carried on a plate coupled to the door handle assembly and extending from the plate in a direction toward the door lock preventing movement of the handle assembly which would move the fork in a direction to actuate the door lock actuator and unlatch the door lock.

2. The vehicle door opening prevention apparatus of claim 1 wherein:
the spacer is integrally formed with the plate.

3. The vehicle door opening prevention apparatus of claim 1 wherein:
the spacer extends substantially perpendicularly from the plate.

4. The vehicle door opening prevention apparatus of claim 1 wherein:
the spacer has the same cross-sectional thickness as the plate.

5. A door handle apparatus for a vehicle door having a door lock assembly for latching and unlatching the door with respect to the vehicle, the door handle apparatus comprising:
door handle assembly mounted in a door outer panel of the vehicle door, and carrying a movable handle accessible exteriorly of the vehicle door, the handle movable relative to the door to a position to open the door;
a door lock assembly carried on the vehicle door, an actuator pin extending from the door lock assembly and movable from a first position in which a door lock is latched to a second position in which the door lock is unlatched to allow opening of the vehicle door;
a fork coupled to the door handle assembly and engaged with the actuator pin for moving the actuator pin to the second position to unlatch the door when the door handle is moved away from the vehicle door; and
a door operation actuation prevention apparatus carried on the door handle and including a plate mounted on the door handle assembly and a spacer carried on the plate extending toward the door lock assembly within the vehicle door to prevent movement of the door handle assembly toward the door lock assembly a distance which would cause the fork to move the actuator pin to the second door unlatched position.

6. The vehicle door handle apparatus of claim 1 wherein:
the spacer is integrally formed with the plate.

7. The vehicle door handle apparatus of claim 5 wherein:
the spacer extends substantially perpendicularly from the handle frame.

8. The door handle apparatus of claim 5 wherein:
the spacer has the same cross-sectional thickness as the plate.

9. A vehicle door comprising:
an outer door panel joined to an inner door panel;
a handle frame mounted in the vehicle door and outer panel including a movable handle;
a door lock mounted in the vehicle door;
an actuator pin coupled to the door lock and movable from a first position corresponding to a latched position of the door lock and a second position in which the actuator pin unlatches the door lock to allow opening of the vehicle door when the handle is moved relative to the handle frame;
a fork carried by the handle and engageable with the actuator pin to move the door lock actuator to the second unlatched position when the handle is moved relative to the vehicle door; and
a spacer carried on a plate coupled to the handle frame and angularly disposed between the door lock and the plate to limit movement of the handle frame toward the door lock under impact forces to prevent movement of the door lock actuator pin to the second position thereby preventing unlatching of the door lock.

10. The vehicle door of claim 9 wherein:
the spacer is integrally formed with the handle frame.

11. The vehicle door of claim 9 wherein:
the spacer extends substantially perpendicularly from the handle frame.

12. The vehicle door of claim 9 wherein:
the spacer has the same cross-sectional thickness as the plate.
